(19) United States
(12) Patent Application Publication
(10) Pub. No.: US 2026/0326095 A1
(43) Pub. Date: Oct. 22, 2026

(54) Electronic Pipette

(71) Applicant: Thermo Fisher Scientific Oy, Vantaa (FI)

(72) Inventor: Katja Eklin, Espoo (FI)

(21) Appl. No.: 19/463,460

(22) Filed: Jan. 29, 2026

Related U.S. Application Data
(60) Provisional application No. 63/752,182, filed on Jan. 31, 2025.

(51) Int. Cl. B01L 3/02

(52) U.S. Cl. CPC B01L 3/0237; B01L 3/0227; B01L 3/0279; B01L 2200/143; B01L 2300/027; B01L 2300/0832; B01L 2400/0478

(57) ABSTRACT

The electronic pipette comprises a cylinder, a piston configured to be moved in the cylinder to aspirate and dispense liquid, a control system, a motor for moving the piston, tip ejection means configured to be moved by a motor when a tip ejection function is activated to detach a pipette tip from the pipette, and a tip ejection button for activating the tip ejection function, wherein the control system is configured to enable and disable the tip ejection function based on the state of the pipette, the pipette comprises tip ejection indicator means comprising at least one indicator light and having a first state indicating enabled step ejection function and a second state indicating disabled tip ejection function, and the control system is configured to switch the tip ejection indicator means to the first or second state depending on whether the tip ejection function is enabled or disabled.

### RELATED APPLICATIONS

The present application claims priority to and the benefit of United States patent application no. 63/752,182, “Electronic Pipette” (filed January 31, 2025). All foregoing applications are incorporated herein by reference in their entireties for any and all purposes.

### Technical Field

The present invention relates to the field of electronic pipettes.

### Background

Pipettes used for liquid dosage in laboratories comprise a piston movable in a cylinder and serving to aspire liquid into and to dispense liquid from a pipette tip according to a selected pipetting function. The liquid volume is usually adjustable. Many pipettes are electronic pipettes, in which the piston is actuated by means of an electric motor and an associated control system. The motor can also be used for detaching the pipette tip from the pipette. Electronic pipettes have a control system and an associated user interface for setting the liquid volume to be aspirated or dispensed, for setting and changing settings of different pipette functions and for giving commands for performing operations. The user interface can comprise keys for this. The user interface may also comprise a display, by means of which the volume and any other necessary data can be displayed. The display can also show menus allowing selection of functions and input of settings by means of the keys. The display can be a touch display functioning also as input means. When the desired function has been selected and the volume and other settings have been entered, depression of the actuation switch automatically carries out the following step of the function until the entire function has been completed.

Electronic pipettes can provide precise and repeatable aspiration and dispensing. In some electronic pipettes, the electric motor used for aspirating and dispensing liquid can also be used for removing the pipette tip. The pipette tip is typically retained by friction force.

### Summary

An object of the invention is to provide an improved electronic pipette.

The electronic pipette according to the invention comprises
a tip portion configured to receive at least one pipette tip that can be detachably attached to the tip portion,
at least one cylinder,
a piston protruding into said at least one cylinder and configured to be moveable in a reciprocating manner to aspirate liquid into a pipette tip and to dispense liquid from the pipette tip when the pipette tip is attached to the tip portion of the pipette,
a control system configured to control the operation of the pipette,
a motor configured to move the piston based on commands from the control system,
tip ejection means configured to be moved by a motor of the pipette when a tip ejection function is activated to detach said at least one pipette tip from the pipette, and
a tip ejection button for activating the tip ejection function,
   wherein the control system is configured to enable and disable the tip ejection function based on the state of the pipette,
   wherein the pipette comprises tip ejection indicator means comprising at least one indicator light and having a first state indicating that the tip ejection function is enabled and a second state indicating that the tip ejection function is disabled, and
   wherein the control system is configured to switch the tip ejection indicator means to the first state when the tip ejection function is enabled and to switch the tip ejection indicator means to the second state when the tip ejection function is disabled.

In the electronic pipette according to the invention, the control system is configured to enable and disable the tip ejection function based on the state of the pipette. This helps avoiding accidental ejecting of the pipette tips. The tip ejection function can be disabled, for instance, during aspiration and dispensing of liquid. The tip ejection function can also be disabled, for instance, when a pipetting function comprising a plurality of actions has not been completed. Such a pipetting function could be, for instance, direct pipetting, reverse pipetting, repetitive reverse pipetting, stepped pipetting, diluting, or mixing.

If a user of the pipette is not aware that the tip ejection function is disabled, the user may unnecessarily keep pushing the tip ejection button to eject the pipette tip. Also, if the tip ejection function is enabled but the user is not aware of that, the user may accidentally eject the pipette tip. In the electronic pipette according to the invention, the tip ejection indicator means inform the user whether the tip ejection function is enabled or disabled. This helps avoiding both accidental ejection of the pipette tip and unnecessary pushing of the tip ejection button. Furthermore, used pipette tips are typically ejected into a trash can, which can be located to a side from a dispensing work area. The user of the pipette may thus need to stretch out his or her arm to reach the trash can. If the tip ejection function is not enabled, this stretching causes unnecessary strain. With the pipette according to the invention, waste of the pipette tips, loss of liquid material and fail of experiments are reduced. Also physical and mental strain and stress of the user are reduced.

According to one aspect of the invention, said at least one indicator light can be arranged to illuminate the tip ejection button.

According to one aspect of the invention, said at least one indicator light can be a LED arranged underneath the tip ejection button.

According to one aspect of the invention, said at least one indicator light can be arranged next to the tip ejection button.

According to one aspect of the invention, said at least one indicator light can be configured to at least partly encircle the tip ejection button.

According to one aspect of the invention, in the first state of the tip ejection indicator means said at least one indicator light can be switched on and in the second state of the tip ejection indicator means said at least one indicator light can be switched off.

According to one aspect of the invention, in the first state of the tip ejection indicator means said at least one indicator light can be switched off and in the second state of the tip ejection indicator means said at least one indicator light can be switched on.

According to one aspect of the invention, the tip ejection indicator means can comprise at least a first indicator light and a second indicator light, and in the first state of the tip ejection indicator means the first indicator light is switched on and the second indicator light is switched off, and in the second state of the tip ejection indicator means the first indicator light is switched off and the second indicator light is switched on.

According to one aspect of the invention, the first indicator light can be configured to produce light having a first color and the second indicator light can be configured to produce light having a second color that is different than the first color.

According to one aspect of the invention, the first indicator light can be arranged behind a translucent cover having a first color and the second indicator light can be arranged behind a translucent cover having a second color that is different than the first color.

According to one aspect of the invention, the tip ejection indicator means can be arranged in the tip portion of the pipette.

According to one aspect of the invention, the tip ejection indicator means can be arranged in a handle portion of the pipette.

According to one aspect of the invention, the tip ejection indicator means can be arranged in a display portion of the pipette.

According to one aspect of the invention, the tip ejection button can be arranged in the display portion of the pipette.

According to one aspect of the invention, the tip ejection means can be configured to be moved by the same motor as said at least one piston.

According to one aspect of the invention, the tip ejection button can be dedicated solely to activation of the tip ejection function.

According to one aspect of the invention, the tip ejection means can comprise a tip ejector coupler that is configured to be moveable by the motor and a tip ejector part that is configured to contact said at least one pipette tip to detach the pipette tip from the pipette.

According to one aspect of the invention, the tip ejector coupler can be configured to mechanically connect to the tip ejector part via an intermediate part when the tip ejector coupler is moved to detach the pipette tip.

According to one aspect of the invention, the control system can be configured to disable the tip ejection function at least during aspiration and dispensing movements of the piston, when the piston is in a position directly following an aspiration step, and when the piston is in an intermediate position during a dispensing function comprising two or more dispensing steps.

According to one aspect of the invention, the control system can be configured to enable the tip ejection function when the piston is in a home position before aspiration, after blowout or after tip ejection.

According to one aspect of the invention, the control system can be configured to enable the tip ejection function when the pipette is in a home screen state of a pipetting function.

According to one aspect of the invention, said at least one pipette tip can be configured to be attached to the tip portion of the pipette by friction.

According to one aspect of the invention, said at least one pipette tip can be configured to be attached to the pipette by clipping means.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various aspects discussed in the present document.

Embodiments of the invention are described below in more detail with reference to the accompanying drawings, in which

FIG. 1 shows a perspective view of an electronic pipette according to an embodiment of the invention without a pipette tip,

FIG. 2 shows a cross-sectional view of the pipette of FIG. 1,

FIG. 3 shows the electronic pipette of FIG. 1 with a pipette tip,

FIG. 4 shows a cross-sectional view of the electronic pipette of FIG. 3,

FIG. 5 shows a multichannel pipette according to an embodiment of the invention without pipette tips,

FIG. 6 shows the multichannel pipette of FIG. 5 with pipette tips,

FIG. 7 shows a cross-sectional view of part of an electronic pipette according to an embodiment of the invention,

FIG. 8 shows as a block diagram parts of a pipette according to an embodiment of the invention,

FIG. 9 shows an example of when a tip ejection function can be enabled and disabled during direct pipetting, and

FIG. 10 shows an example of when the tip ejection function can be enabled and disabled during stepped pipetting.

### DETAILED DESCRIPTION

The present disclosure may be understood more readily by reference to the following detailed description of desired embodiments and the examples included therein.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise.

As used in the specification and in the claims, the term “comprising” can include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter

Unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently of the endpoints. The endpoints of the ranges and any values disclosed herein are not limited to the precise range or value; they are sufficiently imprecise to include values approximating these ranges and/or values.

As used herein, approximating language can be applied to modify any quantitative representation that can vary without resulting in a change in the basic function to which it is related. Accordingly, a value modified by a term or terms, such as “about” and “substantially,” may not be limited to the precise value specified, in some cases. In at least some instances, the approximating language can correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” can refer to plus or minus 10% of the indicated number. For example, “about 10%” can indicate a range of 9% to 11%, and “about 1” can mean from 0.9-1.1. Other meanings of “about” can be apparent from the context, such as rounding off, so, for example “about 1” can also mean from 0.5 to 1.4.

Further, the term “comprising” should be understood as having its open-ended meaning of “including,” but the term also includes the closed meaning of the term “consisting.” For example, a composition that comprises components A and B can be a composition that includes A, B, and other components, but can also be a composition made of A and B only. Any documents cited herein are incorporated by reference in their entireties for any and all purposes.

Any embodiment or aspect provided herein is illustrative only and does not limit the scope of the present disclosure or the appended claims. Any part or parts of any one or more embodiments or aspects can be combined with any part or parts of any one or more other embodiments or aspects.

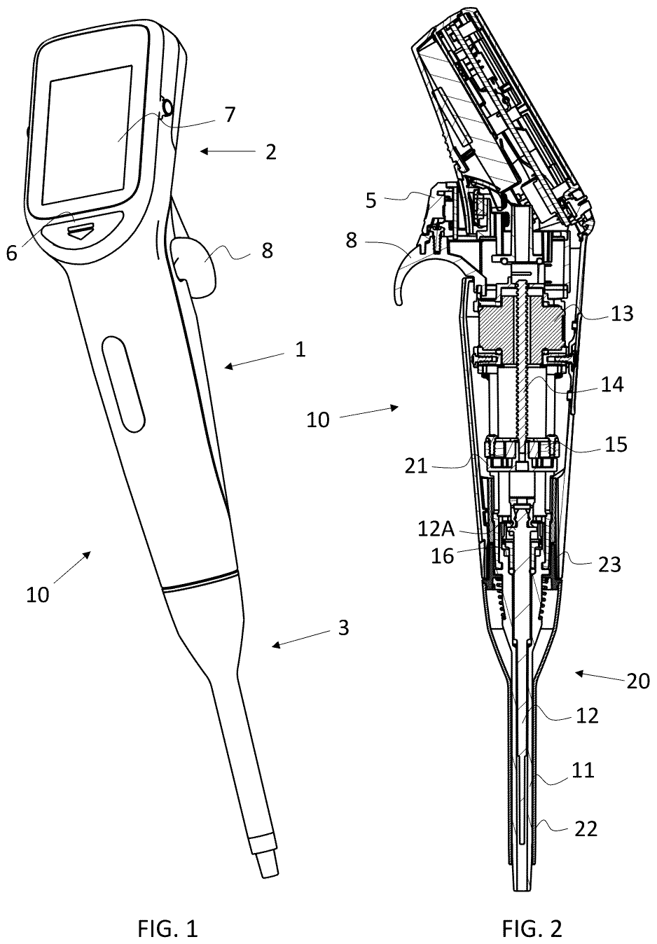

FIGS. 1 to 4 show different views of an electronic pipette 10 according to an embodiment of the invention. The pipette 10 comprises a handle portion 1, a tip portion 3 and a display portion 2. The electronic pipette 10 is a handheld device. The handle portion 1 is configured to be gripped by a hand of a user of the pipette 10. In a use position of the pipette 10, the tip portion 3 is located below the handle portion 1 and the display portion 2 is located above the handle portion 1. The handle portion 1 comprises a hook 8 that is configured to be supported against a finger of the user.

The pipette 10 comprises an actuation switch 5 that can be used for operating the pipette 10, in particular for starting an aspiration or dispensing function or step. The display portion 2 is provided with a display 7 that is configured to show various information to the user. The display 7 can be a touch display that can be used for operating the pipette 10. In the embodiment of FIGS. 1 to 4, the display portion 2 is further provided with a tip ejection button 6, which can be used for ejecting a pipette tip, as will be described later. The tip ejection button 6 could also be located differently.

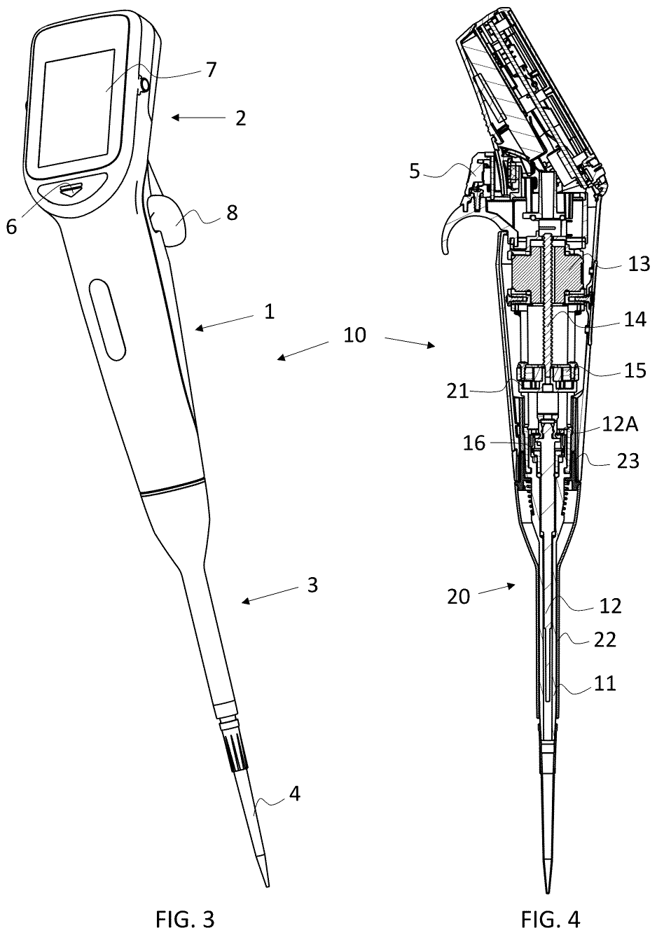

FIGS. 3 and 4 show a pipette tip 4 attached to the tip portion 3. The pipette tip 4 is detachably attached to the tip portion 3 of the pipette 10. The pipette 10 can be configured to allow different pipette tips to be attached to the pipette 10. For instance, the pipette tips 4 may have different lengths and/or volumes and some pipette tips may be provided with a filter. In the embodiment of FIGS. 1 to 4, the pipette tip 4 is attached to the tip portion 3 of the pipette 10 by friction. Both the pipette tip 4 and the lower end of the tip portion 3 are conical. The largest inner diameter of the pipette tip 4 is greater than the smallest outer diameter of the tip portion 3. The tip portion 3 can thus receive part of the pipette tip 4 around the lower end of the tip portion 3. The pipette tips 4 are typically made of a plastic material having some elasticity. The user of the pipette 10 pushes the pipette tip 4 around the conical lower part of the tip portion 3 and the pipette tip 4 is retained in the tip portion 3 by friction force. However, the tip portion 3 and the pipette tips 4 could also be configured such that the pipette tip 4 is fastened to the tip portion 3 by a form-fit connection. Each of the tip portion 3 and the pipette tip 4 can thus be provided with a form that is configured to cooperate with the respective form of the other part. For instance, the pipette tip 4 can be attached to the tip portion 3 by clipping means.

The pipette tip could also be a syringe tip, which comprises an integrated piston that is in contact with the liquid that is aspirated into the tip.

The pipette 10 comprises a cylinder 11 and a piston 12 protruding into the cylinder 11. The piston 12 is configured to be moveable in a reciprocation manner for aspirating liquid into the pipette tip 4 and dispensing liquid from the pipette tip 4. As the piston 12 moves upwards in the cylinder 11 when the open end of the detachable pipette tip 4 is immersed in liquid, a partial vacuum is generated and liquid is aspirated into the pipette tip 4. As the piston 12 moves downwards, the liquid is dispensed from the pipette tip 4.

The pipette 10 comprises an electric motor 13 for moving the piston 12. The motor 13 can be a stepper motor. However, the motor 13 could also be some other type of motor. The motor 13 is mechanically coupled to the piston 12 such that rotational movement of the motor 13 can be converted into linear movement of the piston 12. The piston 12 is thus configured to be moved by the motor 13 for aspirating liquid into the pipette tip and for dispensing liquid from the pipette tip.

In the embodiment of FIGS. 1 to 4, the piston 12 is coupled to the motor 13 by means of a threaded rod 14. The motor 13 is configured to rotate the threaded rod 14, and as the threaded rod 14 rotates, it moves in a direction that is parallel to the axial direction of the cylinder 11. The threaded rod 14 is coupled to the piston 12 by means of a piston coupler 15.

In the embodiment of FIGS. 1 to 4, the motor 13 is further configured to be used for detaching the pipette tip 4 from the pipette 10 after pipetting. In the embodiment of FIGS. 1 to 4, the pipette 10 comprises tip ejection means 20 that are configured to be moveable by the motor 13 for detaching the pipette tip 4. When a tip ejection function is activated, the motor 13 moves the tip ejection means 20 to detach the pipette tip 4. The tip ejection function can be activated by pushing the tip ejection button 6. Instead of using the same motor 13 for moving the piston 12 and for ejecting the pipette tips 4, the pipette could comprise a separate motor for operating the tip ejection means 20.

In the embodiment of FIGS. 1 to 4, the tip ejection means 20 comprise a tip ejector coupler 21 and a tip ejector part 22. The tip ejector coupler 21 is attached to the threaded rod 14. During dispensing movement, the piston coupler 15 and the tip ejector coupler 21 move together and also the piston 12 is thus moved. The tip ejector coupler 21 is releasably attached to the piston coupler 15. The pipette 10 can be provided for example with a magnet and a metal part configured to cooperate with the metal part to attach the tip ejector coupler 21 and the piston coupler 15 together. However, also some other type of releasable connection means could be used.

The piston 12 is provided with a flange 12A. As the piston 12 reaches the end of the dispensing movement, the flange 12A contacts a stopper surface 16 and further movement of the piston 12 and the piston coupler 15 is prevented by the stopper surface 16, but the tip ejector coupler 21 is allowed to move further. When the tip ejection function is activated, the motor 13 is rotated to move the threaded rod 14 further in the dispensing direction. The threaded rod 14 moves the tip ejector coupler 21 further. The tip ejector coupler 21 is configured to mechanically connect to the tip ejector part 22 via an intermediate part 23. As the tip ejector part 22 moves downwards, it pushes the pipette tip 4 and detaches the pipette tip 4 from the tip portion 3 of the pipette 10. The tip ejector part 22 is returned to the start position by spring force.

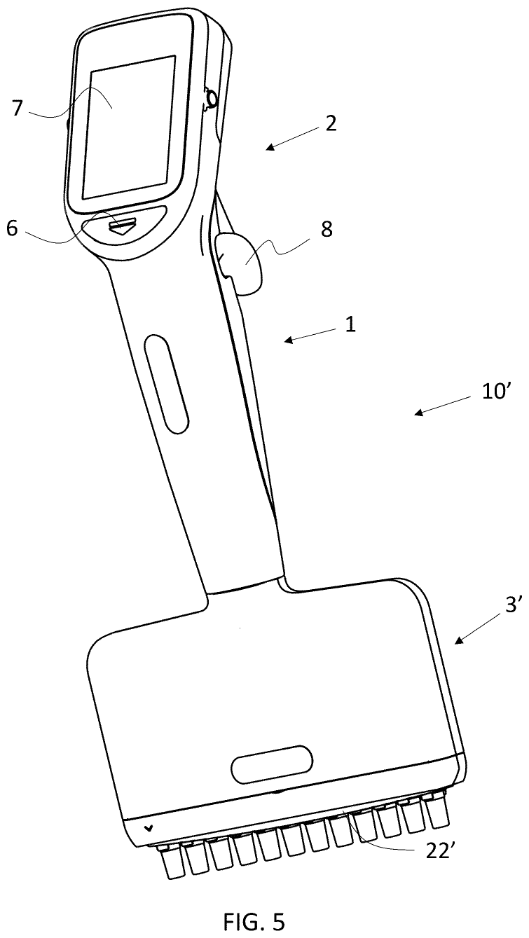

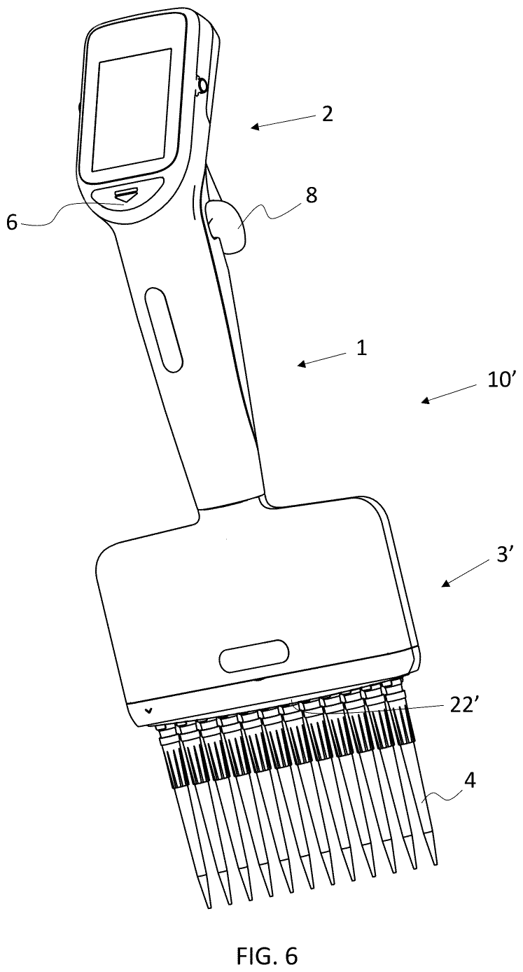

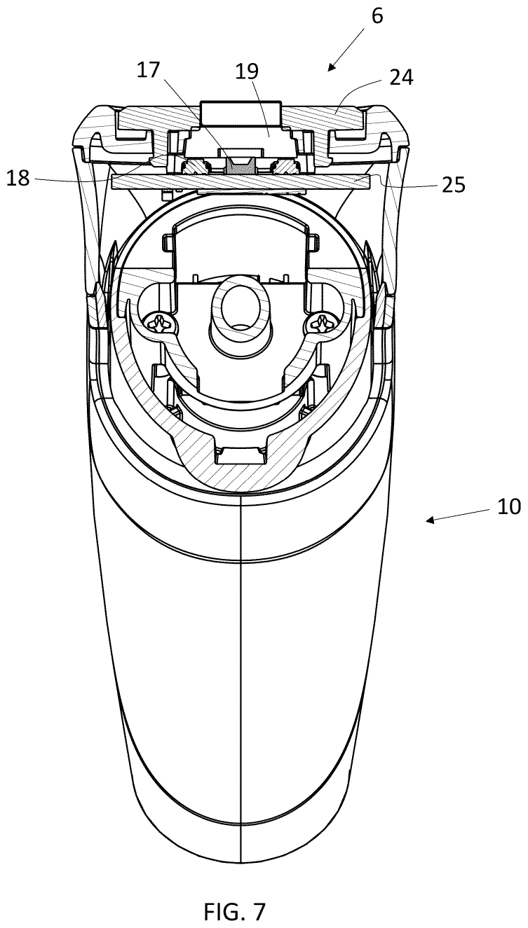

FIGS. 5 and 6 show a pipette 10′ according to another embodiment of the invention. In the embodiment of FIGS. 5 and 6, the handle portion 1 and the display portion 2 are identical to the respective parts of the pipette 10 shown in FIGS. 1 to 4. The tip portion 3′, however, differs from the tip portion 3 of the pipette 10 of FIGS. 1 to 4. In the embodiment of FIGS. 5 and 6, the pipette 10′ is a multichannel pipette. The pipette 10′ comprises a plurality of cylinders and an equal number of pistons. The motor of the pipette 10′ is configured to move simultaneously all the pistons of the pipette 10′. For each cylinder of the pipette 10', one pipette tip 4 can be attached to the pipette 10′. Also the pipette 10′ of FIGS. 5 and 6 is provided with tip ejection means. The tip ejection means comprise a tip ejector part 22′ that can be moved by the motor 13 of the pipette 10′. As the tip ejector part 22′ moves in the dispensing direction of the pistons of the pipette 10′, the pipette tips 4 are detached from the tip portion 3′ of the pipette. The tip ejector part 22′ can be mechanically connected to the motor 13 in a similar way as in the embodiment of FIGS. 1 to 4.

The tip ejector part 22′ or force transmission means between the tip ejector coupler and the tip ejector part can be configured such that the pipette tips 4 are not detached simultaneously with each other. This reduces the force needed to remove the pipette tips 4. For instance, the tip ejector part 22′ can be shaped such that the tip ejector part 22′ contacts at least some of the pipette tips 4 at a slightly different time than the other pipette tips 4. In the embodiment of FIGS. 5 and 6, the tip ejector part 22′ is shaped to contact the pipette tips 4 in the middle of the row of the cylinders before the pipette tips 4 at the ends of the row of cylinders.

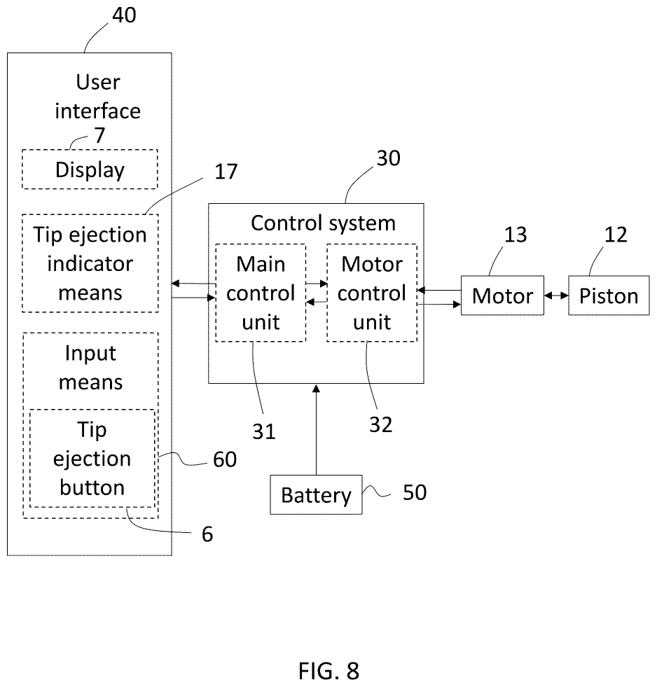

FIG. 8 shows as a block diagram parts of a pipette according to an embodiment of the invention. The pipette comprises a control system 30 for controlling the operation of the pipette. The control system 30 is operatively connected to the motor 13 and to the user interface 40 of the pipette. The user interface 40 comprises at least input means 60 that allow a user of the pipette to operate the pipette. The input means 60 comprise at least a tip ejection button 6. The term “user interface” refers here to all the elements that are intended for communication between the pipette and a user of the pipette. Each of the elements can be configured for one-way or two-way communication. The elements can thus inform the user or to receive commands from the user or both transmit and receive information.

The user interface 40 can further comprise a display 7 for showing information to the user. The display 7 can be a touch display forming at least part of the input means 60 of the pipette. Instead of a touch display or in addition to it, the input means 60 can comprise one or more push-buttons or other similar means, such as the actuation switch 5 and/or other operating keys. The user interface 40 can comprise two or more displays.

The user interface 40 further comprises tip ejection indicator means 17. The tip ejection indicator means 17 comprise at least one indicator light. The indicator light can be arranged to illuminate the tip ejection button 6. The indicator light can be a LED arranged underneath the tip ejection button 6. Alternatively, the indicator light could be arranged next to the tip ejection button 6. The indicator light could also be arranged in the tip portion 3, for instance in a lower part of the tip portion 3. The indicator light could be arranged close to the pipette tip 4. The indicator light 17 can be, for instance, a single-color, bi-color or multi-color LED. The indicator light can be, for instance, a white LED.

The tip ejection indicator means 17 are configured to inform the user of the pipette whether ejection of the pipette tip 4 is possible. Therefore, the tip ejection indicator means 17 have a first state indicating that the tip ejection function is enabled and a second state indicating that the tip ejection function is disabled. The control system 30 is configured to switch the tip ejection indicator means 17 to the first state when the tip ejection function is enabled and to switch the tip ejection indicator means 17 to the second state when the tip ejection function is disabled. In the first state of the tip ejection indicator means the at least one indicator light could be switched on, and in the second state of the tip ejection indicator means the at least one indicator light could be switched off. However, it is also possible that enabled tip ejection function is indicated with an indicator light that is switched off and disabled enabled tip ejection function is indicated with an indicator light that is switched on. The first and second state of the tip ejection indicator means can also be lights with different colors. The lights with different colors can be produced with one or more light sources, for instance by using two LEDs or by using a single bi-color or multi-color LED.

The user interface 40 can also comprise other signal means for transmitting information to the user of the pipette. For instance, the pipette can comprise one or more signal lights and/or audio means for informing the user.

The control system 30 can comprise a main control unit 31 and a motor control unit 32. The main control unit 31 can comprise various components, such as a central processing unit (CPU), a non-volatile memory and a volatile memory. The non-volatile memory can be used for storing a computer program configured to operate the electronic pipette based on the commands given by the user of the pipette via the input means. The non-volatile memory can also be used for storing settings and functions inputted by the user. The pipette comprises a battery 50 that powers the control system 30, user interface 40 and the motor 13.

The main control unit 31 is operatively connected to the motor control unit 32. The motor control unit 32 can be an integral part of the motor 13. The motor control unit 32 is configured to receive operating commands from the main control unit 31. Based on the operating commands received from the main control unit 31, the motor control unit 32 controls the electric current fed to the motor 13. The motor control unit 32 can further control the voltage of the power supply to the motor 13.

The control system 30 is configured to enable and disable the tip ejection function based on the state of the pipette. When the tip ejection function is disabled, pushing of the tip ejection button 6 does not activate the tip ejection function. This reduces the risk of accidental tip ejection. The tip ejection function can be disabled at least during aspiration and dispensing, i.e. when the piston 12 is moving. The tip ejection function can be disabled also in other situations. For instance, when a pipetting function comprising a plurality of pipetting actions has not been completed, the tip ejection function can be disabled. The user of the pipette thus needs to complete the pipetting function or to abort the pipetting function before the tip ejection function is enabled. The pipetting function could be, for instance, direct pipetting, reverse pipetting, repetitive reverse pipetting, stepped pipetting, diluting, or mixing. The pipette may be configured to allow a user of the pipette to create own pipetting functions. For instance, the user may be allowed to create a tip ejection step, in which tip ejection is enabled.

According to one example, the tip ejection function is disabled when the piston is in a position directly following an aspiration step. Liquid has thus been aspirated into the pipette tip, the piston is stationary and the pipette is ready for dispensing. Furthermore, the tip ejection function can be disabled when the piston is in an intermediate position during a dispensing function comprising two or more dispensing steps (stepped pipetting). In stepped pipetting, the liquid aspirated into the pipette tip is dispensed in a plurality of portions. In the pipettes 10, 10′ of FIGS. 1 to 6, each portion is dispensed by pressing the actuation switch 5. If a predetermined number of portions has not been dispensed, the tip ejection function is disabled. When the user has dispensed the predetermined number of portions, the control system 30 can enable the tip ejection function. Alternatively, the tip ejection function can be enabled after blowout. The user can then detach the pipette tip 10 by pushing the tip ejection button 6.

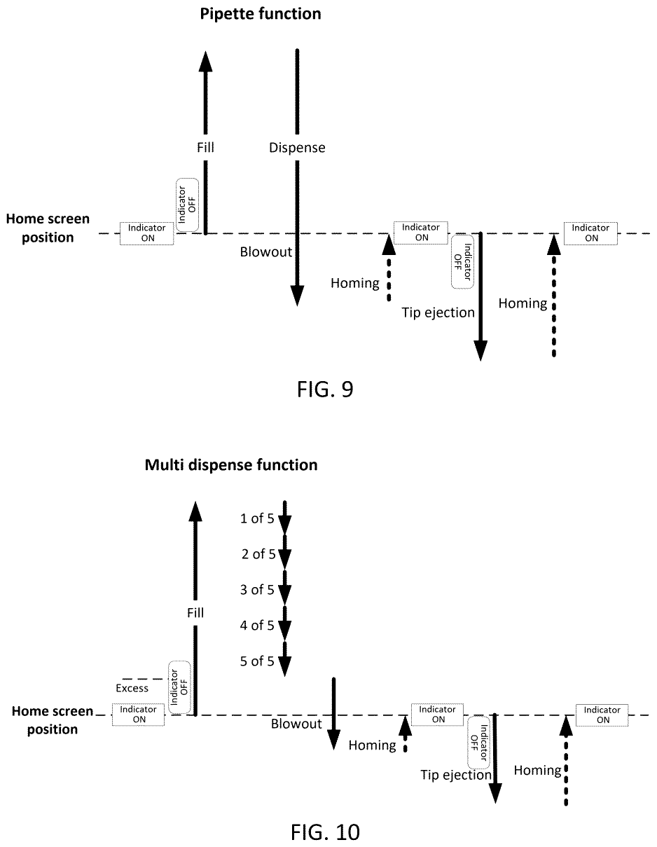

FIGS. 9 and 10 show two examples of how the control system can be configured to enable and disable the tip ejection function.

In the example of FIG. 9, the pipette is used for direct pipetting. Liquid is thus aspirated into the pipette tip and all the liquid is dispended by a single dispensing stroke. To discharge all the liquid from the pipette tip, the dispensing stroke includes a blowout. The piston thus moves during the dispensing beyond the starting position of the aspiration stroke. The term “Home screen position” in FIG. 9 refers to the information displayed on the display of the pipette. The home screen is displayed to the user when there is no liquid in the pipette tip and the pipette is thus ready for aspiration, tip ejection or attaching of a new pipette tip.

Before aspiration, the tip ejection function is enabled, and the tip ejection indicator means 17 are in the first state, which is shown in FIG. 9 as “Indicator ON”. When the user presses the actuation switch and the piston starts moving, the tip ejection function is disabled and the tip ejection indicator means 17 are switched to the second state, which is shown in FIG. 9 as “Indicator OFF”. The tip ejection function remains disabled during the dispensing cycle and the following return of the piston to the home position, i.e. to the initial position from which the aspiration movement of the piston started. The home screen is displayed to the user and the tip ejection indicator means are in the first state. As the user pushes the tip ejection button and the tip ejection function is activated, the tip ejection indicator means are switched to the second state. When the tip ejector coupling means return back to the home position, the tip ejection indicator means are switched back to the first state. The tip ejection indicator means could be switched back to the first state already after finishing of the dispensing cycle or during the return movement of the tip ejector coupling means. The tip ejector coupling means can be returned to the home position by spring force, as in the pipettes shown in FIGS. 1 to 6.

In the example of FIG. 10, the pipette is used for stepped pipetting. The aspiration step is similar to the aspiration step of direct pipetting and the tip ejection function is disabled in the same way. In stepped pipetting, the dispensing takes place as several dispensing steps. FIG. 10 shows five steps. To ensure that the desired amount of liquid can be dispensed even by the last dispensing step, an excess amount of liquid is aspirated during the aspiration step. Therefore, some liquid typically remains in the pipette tip even after the last dispensing step. An additional blowout step is needed to dispense the remaining liquid. The liquid may be hazardous, and therefore in the example of FIG. 10 the tip ejection function remains disabled until the blowout step has been completed and the piston has returned to the home position. However, the tip ejection function could be configured to be enabled even before the blowout step has been completed.

The control system of the pipette could also be configured in a different way. For instance, the piston could remain after the blowout in the blowout position, and the tip ejection function could be enabled when the piston is in the blowout position. The user could then select whether to activate the tip ejection function or to return the piston to the home position.

FIG. 7 shows a cross-sectional view of part of a pipette according to one embodiment of the invention. In the embodiment of FIG. 7, the tip ejection indicator means comprise an indicator light 17. The indicator light 17 is a LED that is arranged underneath the tip ejection button 6. Two switches 18 are arranged on a circuit board 25. As the tip ejection button 6 is pushed, it contacts at least one of the switches 18. If the tip ejection function is enabled, the control system activates the tip ejection function and the pipette tip is ejected. The tip ejection button 6 comprises a translucent portion 19. When the tip ejection function is enabled, the indicator light 17 is switched on. The tip ejection button 6 is thus illuminated and the user of the pipette can thus easily detect that the tip ejection function is enabled.

The tip ejection button 6 could also be implemented in many different ways. For instance, the tip ejection button could have an opaque middle part and a translucent perimeter, or the whole tip ejection button could be translucent and optionally have a dark tip ejection symbol. A switch for activating the tip ejection function could be integrated to the indicator light.

If the user wishes to eject the pipette tip, the tip ejection button 6 can be pushed to eject the pipette tip 4. The user may also wish to continue pipetting with the same pipette tip 4. In that case, the indicator light warns the user that pushing of the tip ejection button 6 activates the tip ejection function. The indicator light thus helps avoiding accidental tip ejection. Unnecessary consumption of the pipette tips 4 is thus avoided and also loss of liquid material can be reduced. Also the risk of failing experiments is reduced.

When the user continues pipetting and the pipette is again in a state in which the tip ejection function is disabled, the indicator light 17 is switched off. The user thus knows that tip ejection is not possible and unnecessary pushing of the tip ejection button 6 is avoided. Unnecessary pushing of the tip ejection button 6 causes strain to the user and can also be stressful. The indicator light thus improves work ergonomics and comfort of the user.

The tip ejection indicator means can also be implemented in many alternative ways. For example, it is not necessary to arrange the indicator light underneath the tip ejection button, but the indicator light could be arranged next to the tip ejection button. The indicator light could at least partially encircle the tip ejection button. Alternatively, the indicator light could be an integral part of the tip ejection button. The indicator light could also be located elsewhere in the display portion. The indicator light could also be arranged in the handle portion or in the tip portion, for instance close to the pipette tip.

It is beneficial to arrange the indicator light in connection with the tip ejection button or at least close to the tip ejection button, because the user can then easily associate the indicator light with the tip ejection function. An indicator light arranged close to the pipette tips is an alternative beneficial arrangement, as the user looks at the pipette tips when dispensing and ejecting the tips.

The tip ejection indicator means could comprise two or more indicator lights. The lights could have different colors, and in the first state of the tip ejection indicator means a first indicator light could be switched on and a second indicator light could be switched off. In the second state of the tip ejection indicator means the second indicator light could be switched on and the first indicator light could be switched off. Different colors could thus indicate whether the tip ejection function is enabled or disabled. Instead of using light sources producing light with different colors, both indicator lights could produce white light and be covered by translucent covers having different colors.

The indicator means could also comprises a single LED that can produce light with at least two different colors to indicate whether the tip ejection function is enabled or disabled.

A benefit of having a single LED that indicates enabled tip ejection function when being switched on is that energy consumption of the tip ejection indicator means is small and battery is saved. To further reduce the energy consumption, the indicator light could be switched off when the pipette has been inactive for a certain period of time, for instance for 10 minutes, and/or when the pipette is placed in a stand.

What is claimed:

1. An electronic pipette, comprising:
a tip portion configured to receive at least one pipette tip that can be detachably attached to the tip portion,
at least one cylinder,
a piston protruding into said at least one cylinder and configured to be moveable in a reciprocating manner to aspirate liquid into a pipette tip and to dispense liquid from the pipette tip when the pipette tip is attached to the tip portion of the pipette,
a control system configured to control the operation of the pipette,
a motor configured to move the piston based on commands from the
control system,
tip ejection means configured to be moved by a motor of the pipette when a tip ejection function is activated to detach said at least one pipette tip from the pipette, and
a tip ejection button for activating the tip ejection function,
wherein the control system is configured to enable and disable the tip ejection function based on the state of the pipette,
wherein the pipette comprises tip ejection indicator means comprising at least one indicator light and having a first state indicating that the tip ejection function is enabled and a second state indicating that the tip ejection function is disabled, and
wherein the control system is configured to switch the tip ejection indicator means to the first state when the tip ejection function is enabled and to switch the tip ejection indicator means to the second state when the tip ejection function is disabled.

2. The electronic pipette according to claim 1, wherein said at least one indicator light is arranged to illuminate the tip ejection button, optionally wherein said at least one indicator light is a LED arranged underneath the tip ejection button.

3. The electronic pipette according to claim 1, wherein said at least one indicator light is arranged next to the tip ejection button.

4. The electronic pipette according to claim 1, wherein said at least one indicator light is configured to at least partly encircle the tip ejection button.

5. The electronic pipette according to claim 1, wherein in the first state of the tip ejection indicator means said at least one indicator light is switched on and in the second state of the tip ejection indicator means said at least one indicator light is switched off.

6. The electronic pipette according to claim 1, wherein in the first state of the tip ejection indicator means said at least one indicator light is switched off and in the second state of the tip ejection indicator means said at least one indicator light is switched on.

7. The electronic pipette according to claim 1, wherein in the first state of the tip ejection indicator means said at least one indicator light is configured to produce light having a first color and in the second state of the tip ejection indicator means said at least one indicator light is configured to produce light having a second color that is different than the first color.

8. The electronic pipette according to claim 1, wherein the tip ejection indicator means comprise at least a first indicator light and a second indicator light, and in the first state of the tip ejection indicator means the first indicator light is switched on and the second indicator light is switched off, and in the second state of the tip ejection indicator means the first indicator light is switched off and the second indicator light is switched on, optionally wherein the first indicator light is configured to produce light having a first color and the second indicator light is configured to produce light having a second color that is different than the first color.

9. The electronic pipette according to claim 8, wherein the first indicator light is arranged behind a translucent cover having a first color and the second indicator light is arranged behind a translucent cover having a second color that is different than the first color.

10. The electronic pipette according to claim 1, wherein the tip ejection indicator means are arranged in the tip portion of the pipette.

11. The electronic pipette according to claim 1, wherein the tip ejection indicator means are arranged in a handle portion of the pipette.

12. The electronic pipette according to claim 1, wherein the tip ejection indicator means are arranged in a display portion of the pipette.

13. The electronic pipette according to claim 12, wherein the tip ejection button is arranged in the display portion of the pipette.

14. The electronic pipette according to claim 1, wherein the tip ejection means are configured to be moved by the same motor as said at least one piston.

15. The electronic pipette according to claim 1, wherein the tip ejection button is dedicated solely to activation of the tip ejection function.

16. The electronic pipette according to claim 1, wherein the tip ejection means comprise a tip ejector coupler that is configured to be moveable by the motor and a tip ejector part that is configured to contact said at least one pipette tip to detach the pipette tip from the pipette.

17. The electronic pipette according to claim 16, wherein the tip ejector coupler is configured to mechanically connect to the tip ejector part via an intermediate part when the tip ejector coupler is moved to detach the pipette tip.

18. The electronic pipette according to claim 1, wherein the control system is configured to disable the tip ejection function at least during aspiration and dispensing movements of the piston, when the piston is in a position directly following an aspiration step, and when the piston is in an intermediate position during a dispensing function comprising two or more dispensing steps.

19. The electronic pipette according to claim 1, wherein the control system is configured to enable the tip ejection function when the piston is in a home position before aspiration, after blowout or after tip ejection.

20. The electronic pipette according to claim 1, wherein said at least one pipette tip is at least one of (i) configured to be attached to the tip portion of the pipette by friction or (ii) configured to be attached to the pipette by clipping means.
